(19) United States
(12) Patent Application Publication
(10) Pub. No.: US 2003/0219531 A1
(43) Pub. Date: Nov. 27, 2003

(54) Method of manufacturing a dual color filter cathode ray tube (CRT)

(76) Inventor: Farzad Parsapour, Reading, PA (US)

Correspondence Address: Joseph S. Tripoli, THOMSON multimedia Licensing Inc., Two Independence Way, Post Office Box 5312, Princeton, NJ, 08540-5312, US

(21) Appl. No.: 10/153,764

(22) Filed: May 22, 2002

(51) Int. Cl. B05D 5/06

(52) U.S. Cl. 427/68; 427/157

(57) ABSTRACT

A method of manufacturing a luminescent screen assembly for a cathode ray tube (CRT) is disclosed. The luminescent screen assembly is formed on an interior surface of a faceplate panel of the CRT. The luminescent screen assembly includes a patterned light-absorbing matrix that defines a first set of fields, a second set of fields, and a third set of fields. A first blocking layer is formed over the second set of fields and the third set of fields. A first pigment is then applied to the first set of fields to form a first color filter. The first blocking layer is removed from the second set of fields and the third set of fields, and a second blocking layer is formed over the third set of fields and the first color filter in the first set of fields. A second pigment is then applied to the second set of fields to form a second color filter. The second blocking layer is then removed from the third set of fields and the first color filter in the first set of fields.

### BACKGROUND OF THE INVENTION

1. Field of the Invention

This invention relates to a color cathode ray tube (CRT) and, more particularly to the manufacturing of a luminescent screen assembly having two color filters.

2. Description of the Background Art

A color cathode ray tube (CRT) typically includes an electron gun an aperture mask, and a screen. The aperture mask is interposed between the electron gun and the screen. The screen is located on an inner surface of a faceplate of the CRT tube. The aperture mask functions to direct electron beams generated in the electron gun toward appropriate color-emitting phosphors on the screen of the CRT tube.

The screen may be a luminescent screen. Luminescent screens typically comprise an array of three different color-emitting phosphors (e.g., green, blue and red) formed thereon. Each of the color emitting phosphors is separated from another by a matrix line. The matrix lines are typically formed of a light absorbing black, inert material.

In order to enhance the color contrast of the luminescent screen, a pigment layer, or color filter may be formed between the faceplate panel and the color-emitting phosphor. The color filter typically has a color that corresponds to the color of the color-emitting phosphor formed thereon (e.g., a red-emitting phosphor is formed on a red pigmented filter). The color filter transmits light that is within the emission spectral region of the phosphor formed thereon and absorbs ambient light in other spectral regions, providing a gain in color contrast.

The color filters are typically formed using a subtractive process in which a first color filter layer is deposited on the luminescent screen, and, in a subsequent development process, select portions of the filter layer are removed, such that a first color filter is formed only on select portions of the faceplate panel. Thereafter, a second color filter layer is applied and developed such that a second color filter is formed on select portions of the faceplate panel that are different from those wherein the first color filter are formed. Unfortunately, color filters formed using such a process may adhere to the faceplate panel with sufficient tenacity on portions not intended to be covered therewith causing the faceplate to become contaminated. Color filter contamination reduces the contrast of the luminescent screen.

Thus, a need exists for a method of forming a dual color filter cathode ray tube (CRT) that overcomes the above drawbacks.

### SUMMARY OF THE INVENTION

The present invention relates to a method of manufacturing a dual color filter luminescent screen assembly of a cathode ray tube (CRT). The luminescent screen assembly is formed on an interior surface of a faceplate panel of the CRT tube. The luminescent screen assembly includes a patterned light-absorbing matrix that defines a first set of fields, a second set of fields, and a third set of fields corresponding to one of a blue region, a green region and a red region.

A first blocking layer is applied over the second set of fields and the third set of fields on the faceplate panel. The first blocking layer may comprise a photosensitive material. A first pigment layer is then applied to the first set of fields to form a first color filter. The first pigment layer may comprise, for example, a blue pigment, and may be applied from a suspension comprising, for example, a daipyroxide blue pigment, one or more surface active agents and at least one non-pigmented oxide particle. After the first color filter is formed, the first blocking layer is removed from the second set of fields and the third set of fields, and a second blocking layer is formed over the third set of fields and the first color filter. A second pigment layer is then applied to the second set of fields to form a second color filter. The second pigment layer may comprise, for example, a red pigment, and may be applied from a suspension comprising a daipyroxide red pigment, one or more surface active agents and at least one non-pigmented oxide particle. After the second color filter is formed, the second blocking layer is removed from the third set of fields and the first color filter.

### BRIEF DESCRIPTION OF THE DRAWINGS

The invention will now be described in greater detail, with relation to the accompanying drawings, in which:

FIG. 1 is a plan view, partly in axial section, of a color cathode ray tube (CRT) made according to embodiments of the present invention;

FIG. 2 is a section of the faceplate panel of the CRT of FIG. 1, showing a luminescent screen assembly;

FIG. 3 is a block diagram comprising a flow chart of the manufacturing process of the screen assembly of FIG. 2; and

FIG. 4 depicts views of the interior surface of the faceplate panel luminescent screen assembly during color filter formation.

### DETAILED DESCRIPTION OF THE INVENTION

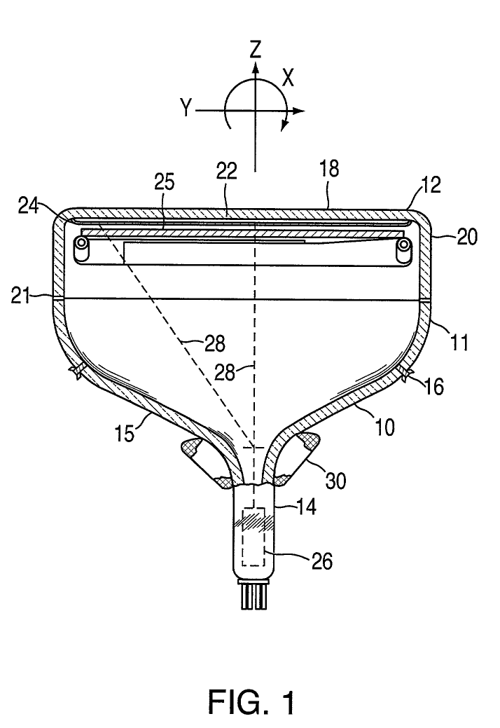

FIG. 1 shows a conventional color cathode ray tube (CRT) 10 having a glass envelope 11 comprising a faceplate panel 12 and a tubular neck 14 connected by a funnel 15. The funnel 15 has an internal conductive coating (not shown) that is in contact with, and extends from, an anode button 16 to the neck 14.

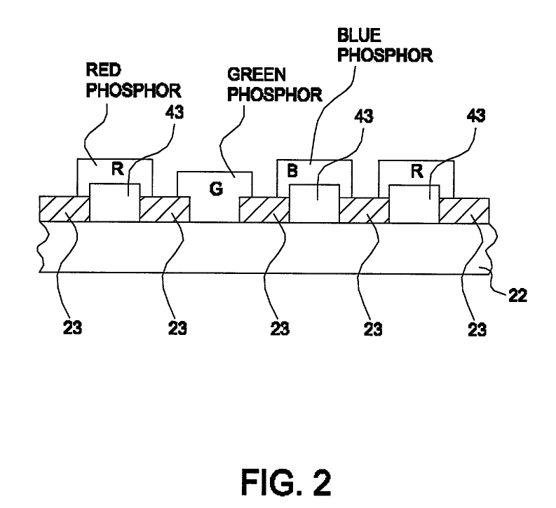

The faceplate panel 12 comprises a viewing surface 18 and a peripheral flange or sidewall 20 that is sealed to the funnel 15 by a glass frit 21. A three-color luminescent phosphor screen 22 is carded on the inner surface of the faceplate panel 12. The screen 22, shown in cross-section in FIG. 2, is a line screen which includes a multiplicity of screen elements comprised of red-emitting, green-emitting, and blue-emitting phosphor stripes R, G, and B, respectively, arranged in triads, each triad including a phosphor line of each of the three colors. The R, G, B, phosphor stripes extend in a direction that is generally normal to the plane in which the electron beams are generated. The R and B phosphor stripes are formed on color filters 43. The color filters 43 each comprise a pigment that corresponds to the color of the phosphor stripe formed thereon.

A light-absorbing matrix 23, shown in FIG. 2, separates each of the phosphor lines. A thin conductive layer 24, preferably of aluminum, overlies the screen 22 and provides means for applying a uniform first anode potential to the screen 22, as well as for reflecting light, emitted from the phosphor elements, through the viewing surface 18. The screen 22 and the overlying aluminum layer 24 comprise a screen assembly.

A multi-aperture color selection electrode, or shadow mask 25 (shown in FIG. 1), is removably mounted, by conventional means, within the faceplate panel 12, in a predetermined spaced relation to the screen 22.

An electron gun 26, shown schematically by the dashed lines in FIG. 1, is centrally mounted within the neck 14, to generate three inline electron beams 28, a center and two side or outer beams, along convergent paths through the shadow mask 25 to the screen 22. The inline direction of the beams 28 is approximately normal to the plane of the paper.

The CRT of FIG. 1 is designed to be used with an external magnetic deflection yoke, such as a yoke 30, shown in the neighborhood of the funnel-to-neck junction. When activated, the yoke 30 subjects the three beams 28 to magnetic fields that cause the beams to scan a horizontal and vertical rectangular raster across the screen 22.

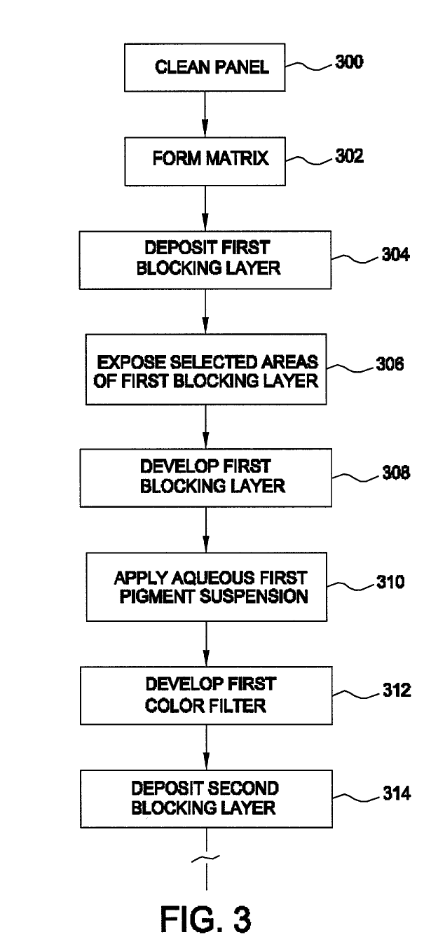

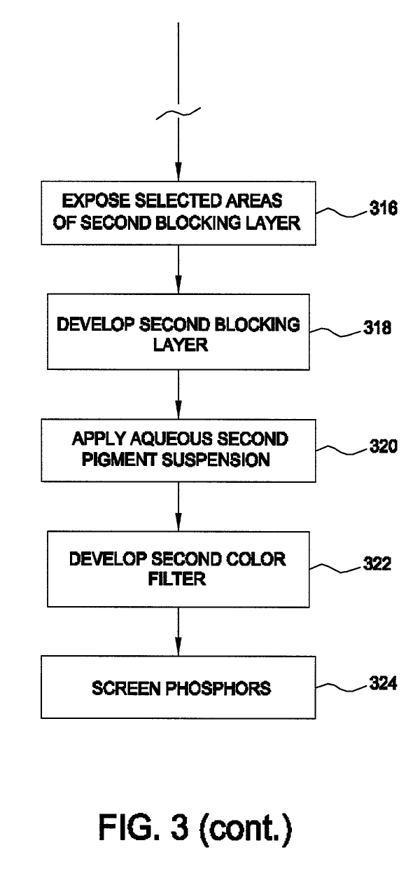

The screen 22 is manufactured according to the process steps represented schematically in FIG. 3. Initially, the faceplate panel 12 is cleaned, as indicated by reference numeral 300, by washing it with a caustic solution, rinsing it in water, etching it with buffered hydrofluoric acid and rinsing it again with water, as is known in the art.

The interior surface of the faceplate panel 12 is then provided with the light-absorbing matrix 23, as indicated by reference numeral 302, preferably using a wet matrix process in a manner described in U.S. Pat. No. 3,558,310, issued Jan. 26, 1971 to Mayaud, U.S. Pat. No. 6,013,400 issued Jan. 11, 2000 to LaPeruta et al., or U.S. Pat. No. 6,037,086 issued to Gorog et al.

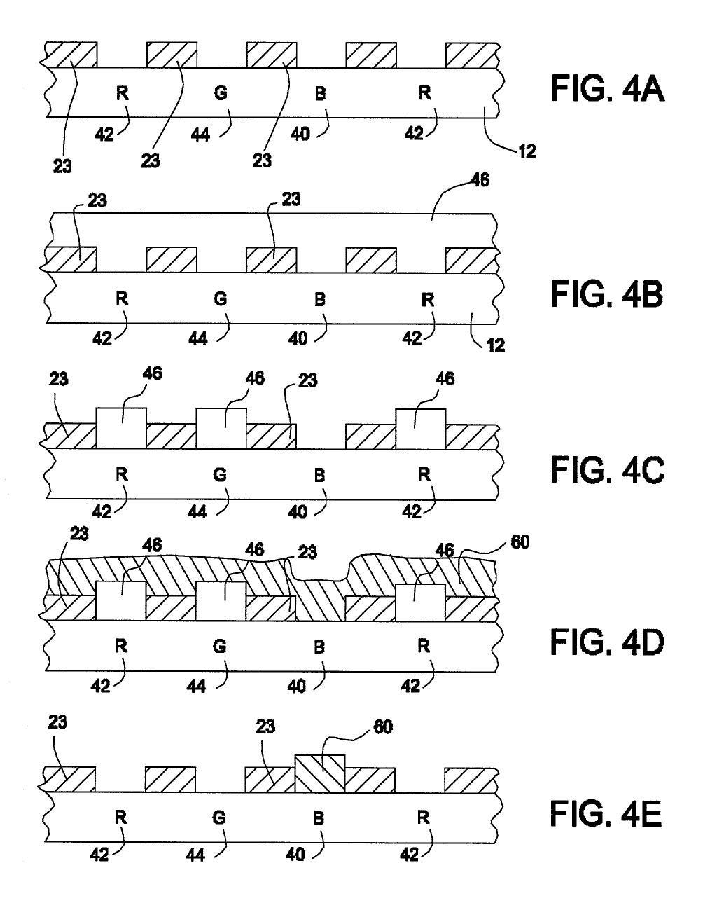

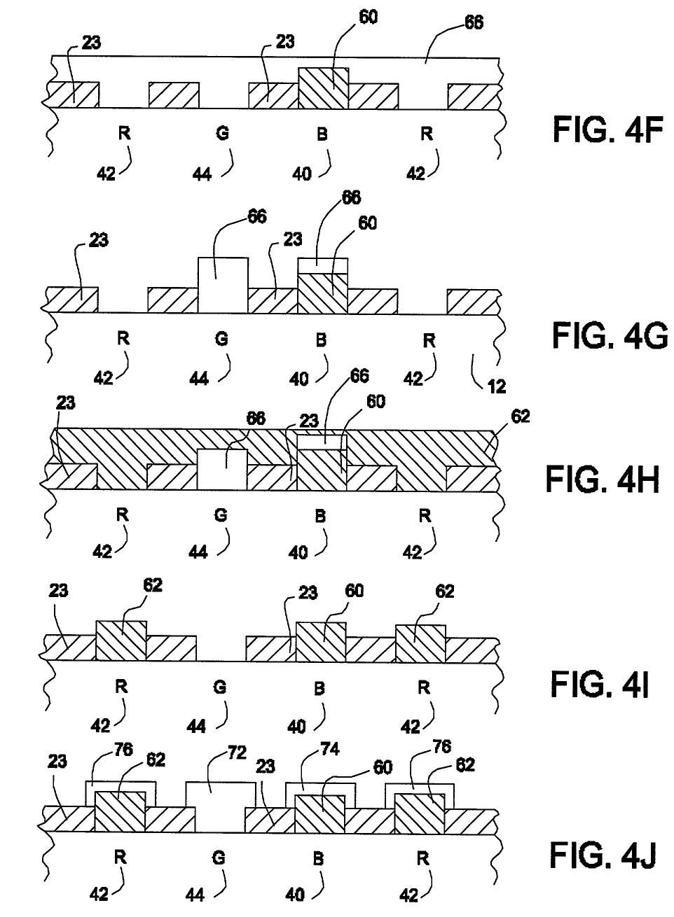

The light-absorbing matrix 23 is uniformly provided over the interior surface viewing of faceplate panel 12. For a faceplate panel 12 having a diagonal dimension of about 68 cm (27 inches), the openings 21 formed in the layer of light absorbing matrix 23 can have a width in a range of about 0.075 mm to about 0.25 mm, and the opaque matrix lines can have a width in a range of about 0.075 mm to about 0.30 mm. Referring to FIG. 4A, the light-absorbing matrix 23 defines three sets of fields: a first set of fields 40, a second set of fields 42, and a third set of fields 44.

As indicated by reference numeral 304 in FIG. 3, as well as FIG. 4B, a first blocking layer 46 is deposited on the interior surface of the faceplate panel 12. The first blocking layer 46 may include a photosensitive material. The photosensitive material may comprise, for example, an aqueous solution of sodium dichromate and a polymer such as polyvinyl alcohol. The first blocking layer 46 may be formed on the faceplate panel 12 by spin coating the aqueous solution of the polymer and dichromate thereon.

Referring to reference numeral 306 in FIG. 3, the first blocking layer 46 is irradiated using, for example, ultraviolet radiation, through the shadow mask 25 to cross-link the photosensitive material in the second set of fields 42 and the third set of fields 44. Cross-linking the first blocking layer 46 in the second set of fields 42 and the third set of fields 44 hardens the photosensitive material in such fields.

The irradiated first blocking layer 46 is then developed as indicated by reference numeral 308 in FIG. 3, as well as FIG. 4C. The first blocking layer 46 may be developed using, for example, deionized water. After development, the first blocking layer 46 is removed over the first set of fields 40, while remaining on the faceplate panel 12 over the second set of fields 42 and the third set of fields 44.

Referring to reference numeral 310 in FIG. 3 as well as FIG. 4D, a first pigment is applied to the first set of fields 40. The first pigment may be applied from a first aqueous pigment suspension that may comprise, for example, the first pigment, one or more surface active agents and at least one non-pigmented oxide particle.

The at least one non-pigmented oxide particles may comprise a material, such as, for example, silica, alumina, or combinations thereof. The at least one non-pigmented oxide particle should have a size less than that of the pigment. Preferably the average size of the at least one non-pigmented oxide particle should be less than about 50 nanometers. The at least one non-pigmented oxide particle is believed to enhance the adhesion of the pigment to the faceplate panel. The at least one non-pigmented oxide particle may be present in a concentration of about 5% to about 10% by weight with respect to the concentration of the pigment.

The first pigment may be, for example, a blue pigment, such as a daipyroxide blue pigment TM-3490E, commercially available from Daicolor-Pope, Inc. of Paterson, N.J. Another suitable blue pigment may include for example, EX 1041 blue pigment, commercially available from Shepherd Color Co. of Cincinnati, Ohio, among other pigments. Alternatively, the first pigment may be a red pigment. Suitable red pigments may include, for example, diapyroxide red pigment TM-3875, commercially available from Diacolor-Pope, Inc. of Paterson, N.J. Another suitable red pigment may include for example, R2899 red pigment, commercially available from Elementis Pigments Co. of Fairview Heights, Ill., among other red pigments.

The pigments may be milled using a ball milling process in which the pigment is dispersed along with one or more surfactants in an aqueous suspension. The blue pigments may be ball milled using for example, 1/16″ zirconium oxide (ZrO₂) balls for at least about 61 hours to about 90 hours. The red pigments may be ball milled using for example, 1/16″ zirconium oxide (ZrO₂) balls for at least about 18 hours to about 92 hours.

The one or more surface-active agents may include, for example organic and polymeric compounds that may optionally adopt an electric charge in aqueous solution. The surface-active agent may comprise, anionic, non-ionic, cationic, and/or amphoteric materials. The surface-active agent may be used for various functions such as improving the homogeneity of the pigment in the aqueous pigment suspension and improved wetting of the faceplate panel, among other functions. Examples of suitable surface-active agents include various polymeric dispersants such as, for example, DISPEX N-40V polymeric dispersant (commercially available from Ciba Specialty Chemicals of High Point, N.C.) as well as block copolymer surface active agents such as Pluronic Series (ethoxypropoxy co-polymers) L-62, commercially available from BASF Corp. of Germany, DAXAD 15 or 19, commercially available from Hampshire Chemical Company of Nashua, N.H., and carboxymethyl cellulose (CMC) commercially available from Yixing Tongda Chemical Co. of China.

The first aqueous pigment suspension may be applied to the faceplate panel by, for example, spin coating in order to form a first color filter layer 60 in the first set of fields 40 of the faceplate panel 12. After spin coating, the first color filter layer 60 may be heated to a temperature in a range from about 55° C. to about 90° C. to provide increased adhesion of the first color filter 60 to the first set of fields 40 of the faceplate panel 12.

Referring to reference numeral 312 as well as FIG. 4E, the first color filter layer 60 is developed by applying an oxidizer to the first blocking layer 46. Suitable oxidizers may include for example, periodic acid and hydrogen peroxide, among others. Water may than be applied to the faceplate panel 12 in order to remove the blocking layer 46 as well as the first color filter layer 60 over the second set of fields 42 and the third set of fields 44, leaving the first color filter 60 remaining in the first set of fields 40.

After the first color filter layer 60 is developed the faceplate panel 12 is heated. The faceplate panel 12 may be heated to a temperature of about 85° C. to about 100° C. and then cooled to a temperature of about 26° C.

The process described above with reference to reference numerals 302 through 312, then is repeated to form a second color filter in the second fields 42 of the faceplate panel 12. Specifically, as indicated by reference numeral 314 in FIG. 3 as well as FIG. 4F, a second blocking layer 66 is deposited on the interior surface of the faceplate panel 12. The second blocking layer 66 has a composition similar to that of the first blocking layer 46 and is applied to the panel 12 using a spin coating technique.

Referring to reference numeral 316 in FIG. 3, the second blocking layer 66 is irradiated using, for example, ultraviolet radiation, through the shadow mask 25 to cross-link the photosensitive material in the third set of fields 44 and over the first color filter 60. Cross-linking the second blocking layer 66 in the third set of fields 44 and over the first color filter 60 hardens the photosensitive material in such regions.

The irradiated second blocking layer 66 is then developed as indicated by reference numeral 318 in FIG. 3 as well as FIG. 4G. The second blocking layer 66 may be developed using, for example, deionized water. After development the second blocking layer 66 is removed in the second set of fields 42, while remaining on the faceplate panel 12 over the third set of fields 40 and the first color filter 60.

Referring to reference numeral 320 in FIG. 3 as well as FIG. 4H, a second pigment layer 62 is applied to the second set of fields 42. The second pigment layer 62 may be applied from a second aqueous pigment suspension that may comprise, for example, the second pigment, one or more surface-active agents and at least one non-pigmented oxide particle. The color of the second aqueous pigment suspension is different from the color of the first aqueous pigment suspension described above.

The second aqueous pigment suspension may be applied to the faceplate panel by, for example, spin coating in order to form a second color filter layer 62 on the faceplate panel 12. The spin-coated second color filter layer 62 may be heated to a temperature within a range from about 55° C. to about 85° C., to provide increased adhesion of the second color filter 62 to the second set of fields 42 of the faceplate panel.

Referring to reference numeral 322 in FIG. 3 as well as FIG. 41, the second color filter layer 62 is developed, by applying an oxidizer to the second blocking layer 66 and rinsing with deionized water, as described above. The second blocking layer 66 as well as the second color filter layer 62 in the third set of fields 44 and over the first color filter 62 are removed, forming a second color filter 62 in the second set of fields 42.

The faceplate panel 12 is then screened with pigmented green phosphors 72, non-pigmented blue phosphors 74 and non-pigmented red phosphors 76, as indicated by reference numeral 324 in FIG. 3 as well as FIG. 4J, preferably, using a screening process in a manner described in U.S. Pat. No. 5,370,952, issued Dec. 6, 1994 to Datta et al., U.S. Pat. No. 5,554,468 issued Sep. 10, 1996 to Datta et al., U.S. Pat. No. 5,807,435 issued Sep. 15, 1998 to Poliniak et al., or U.S. Pat. No. 5,474,866 issued Dec. 12, 1995 to Ritt et al.

In an exemplary luminescent screen assembly fabrication process, a 20 inch faceplate panel having matrix lines formed thereon was soaked in warm water for 30 minutes, sprayed with water at 30 psi for 10 seconds and dried. The faceplate panel was then cooled to 27° C. A solution of 275 grams of water, 160 grams of 10% polyvinyl alcohol, and 21 grams of 10% sodium dichromate was prepared and 120 milliliters of this solution was applied to the faceplate panel. The faceplate panel was spun at 190 rpm for 50 seconds, heated to 53° C. and cooled to 34° C. to form a photosensitive layer on the panel.

The coated faceplate panel was irradiated using an ultraviolet source (0.4 milliwatts per square centimeter) for 40 seconds through a corresponding shadow mask, to cross-link the photosensitive material in the red fields and green fields. The irradiated faceplate panel was developed using 110 OF water at 20 psi for 20 seconds and then dried. This resulted in the formation of a first blocking layer in the red fields and the green fields, and the removal of the blocking layer in the blue fields.

A blue pigment concentrate was prepared by placing 190 grams of water, 7.5 grams of a polymeric dispersant, DISPEX N-40V (commercially available from Ciba Specialty Chemicals of High Point, N.C.) and 50 grams of TM3490E Daipyroxide blue pigment (commercially available from Daicolor-Pope, Inc. of Paterson, N.J.) in a ball mill and milling the mixture using 1/16″ zirconium oxide balls for 62 hours. The average particle size of the blue pigment in the milled concentrate was 115 nanometers (nm).

Ninety-five grams (g) of the blue pigment concentrate (15 weight %) was mixed with 7 grams of deionized water, 5 grams of a colloidal silica, SNOWTEX XS (20% active silica, available from Nissan Chemical Industries of Tokyo, Japan), and 2.5 grams of a 5% Pluronic Series (ethoxypropoxy co-polymer) L-62 solution (commercially available from BASF Corp. of Germany) for 15 minutes to yield an aqueous blue pigment suspension comprising about 13 weight % pigment. The aqueous blue pigment suspension was applied to the faceplate panel at 26° C. and thereafter the panel was spun at 100 rpm for 20 seconds, heated to 65° C. and cooled to 34° C. to form a blue color filter layer on the faceplate panel.

The faceplate panel with the blue color filter layer thereon was heated to a temperature of 55° C. The blue color filter layer was developed by applying 450 ml of a 0.03% periodic acid solution to the faceplate panel. The periodic acid solution was swirled around the panel surface for 90 seconds. Thereafter, the faceplate panel was sprayed with 43° C. water at 40 psi for 15 seconds. This development step removed the first blocking layer with the blue color layer thereon from both the red fields and the green fields, leaving a blue color filter in the blue fields.

After the blue color filter layer is developed the faceplate panel is heated. The faceplate panel was heated to a temperature of 85° C. and then cooled to a temperature of 26° C.

A second blocking layer comprising a photosensitive material was formed on the faceplate panel as indicated above. The coated faceplate panel was irradiated using an ultraviolet source (0.4 milliwatts per square centimeter) through a corresponding shadow mask, to cross-link the photosensitive material in the blue fields and the green fields. The blue fields were irradiated for 60 seconds and the green fields were irradiated for 40 seconds. The irradiated faceplate panel was developed using 43° C. water at 20 psi for 20 seconds and then dried. This resulted in the formation of a second blocking layer in the blue fields and the green fields, and the removal of the blocking layer in the red fields.

A red pigment concentrate was prepared by placing 190 grams of water, 7.5 grams of a polymeric dispersant, DISPEX N-40V and 50 grams of TM3875 Daipyroxide red pigment (commercially available from Diacolor-Pope, Inc. of Paterson, N.J.) in a ball mill and milling the mixture for 90 hours using 1/16″ zirconium oxide balls. The average particle size of the red pigment in the milled concentrate was 85 nanometers (nm).

Ninety-two grams (g) of the red pigment concentrate (12 weight %) was mixed with 13 grams of deionized water and 5 grams of a 5% Pluronic Series (ethoxypropoxy co-polymer) L-62 solution (commercially available from BASF Corp. of Germany) for 10 minutes to yield an aqueous red pigment suspension comprising about 10 weight % pigment. The aqueous red pigment suspension was applied to the faceplate panel at 26° C. and thereafter the panel was spun at 100 rpm for 20 seconds, heated to 65° C. and cooled to 34° C. to form a red color filter layer on the faceplate panel.

The faceplate panel with the red color filter layer thereon was heated to a temperature of 55° C. The red color filter layer was developed by applying 450 ml of a 0.05% periodic acid solution to the faceplate panel. The periodic acid solution was swirled around the panel surface for 2 minute. Thereafter, the faceplate panel was sprayed with 110 OF water at 40 psi for 15 seconds. This development step removed the second blocking layer with the red color layer thereon from both the blue fields and the green fields, leaving a red color filter in the red fields. Pigment cross-contamination between the blue color filter and the red pigment was completely absent.

What is claimed is:

1. A method of manufacturing a luminescent screen assembly for a color cathode-ray tube (CRT), comprising:
providing a faceplate panel having a patterned light absorbing matrix thereon defining a set of first fields, a set of second fields and a set of third fields;
forming a first blocking layer over the set of second fields and the set of third fields;
applying a first pigment to the set of first fields;
heating the faceplate panel to a first temperature;
removing the first blocking layer from the set of second fields and the set of third fields;
heating the faceplate panel to a second temperature;
forming a second blocking layer over the set of third fields and the first pigment in the set of first fields;
applying a second pigment to the set of second fields;
heating the faceplate panel to a third temperature; and
removing the second blocking layer from the set of third fields and the first pigment in the set of first fields.

2. The method of claim 1 wherein the first blocking layer and the second blocking layer each comprise a photosensitive material.

3. The method of claim 1 wherein the first pigment is a blue pigment that is applied from a suspension comprising a diapyroxide blue pigment, one or more surface active agents and at least one non-pigmented oxide particle, wherein the at least one non-pigmented oxide particle has a size smaller than the size of the diapyroxide blue pigment.

4. The method of claim 1 wherein the second pigment is a red pigment that is applied from a suspension comprising daipyroxide red pigment, one or more surface active agents and at least one non-pigmented oxide particle, wherein the at least one non-pigmented oxide particle has a size smaller than the size of the diapyroxide red pigment.

5. The method of claim 1 wherein the second temperature is about 20° C lower that the first temperature.

6. A method of manufacturing a luminescent screen assembly for a color cathode-ray tube (CRT), comprising:
providing a faceplate panel having a patterned light absorbing matrix thereon defining a set of blue fields, a set of red fields and a set of green fields;
forming a first blocking layer over the set of red fields and the set of green fields;
applying blue pigment to the set of blue fields;
heating the faceplate panel to a first temperature;
removing the first blocking layer from the set of red fields and the set of green fields;
heating the faceplate panel to a second temperature;
forming a second blocking layer over the set of green fields and the blue pigment in the set of blue fields;
applying red pigment to the set of red fields;
heating the faceplate panel to a third temperature; and
removing the second blocking layer form the set of green fields and the blue pigment in the set of blue fields.

7. The method of claim 6 wherein the first blocking layer and the second blocking layer each comprise a photosensitive material.

8. The method of claim 6 wherein the blue pigment is applied from a suspension comprising daipyroxide blue pigment, one or more surface active agents and at least one non-pigmented oxide particle, wherein the at least one non-pigmented oxide particle has a size smaller than the size of the blue pigment.

9. The method of claim 6 wherein the red pigment is applied from a suspension comprising daipyroxide red pigment and one or more surface active agents.

10. The method of claim 6 wherein the second temperature is about 85° C.

11. The method of claim 6 wherein the third temperature is about 65° C.

12. The method of claim 6 further comprising forming a green phosphor layer in the set of third fields.

13. The method of claim 12 further comprising forming a non-pigmented blue phosphor layer on the blue pigment in the set of blue fields.

14. The method of claim 13 further comprising forming a red phosphor layer on the red pigment in the set of red fields.
